(19) United States
(12) Patent Application Publication
(10) Pub. No.: US 2019/0079249 A1
(43) Pub. Date: Mar. 14, 2019

(54) OPTICAL CONNECTOR AND ADAPTERS

(71) Applicants: SUMITOMO ELECTRIC INDUSTRIES, LTD., Osaka (JP); SEI Optifrontier Co., Ltd., Yokohama-shi (JP)

(72) Inventors: Yoshikyo TAMEKUNI, Osaka (JP); Kazuya MASUDA, Osaka (JP); Tomohiko UEDA, Osaka (JP); Yuji SUZUKI, Yokohama-shi (JP)

(73) Assignees: SUMITOMO ELECTRIC INDUSTRIES, LTD., Osaka (JP); SEI Optifrontier Co., Ltd., Yokohama-shi (JP)

(21) Appl. No.: 16/127,336

(22) Filed: Sep. 11, 2018

(30) Foreign Application Priority Data
Sep. 14, 2017 (JP) 2017-177080

(51) Int. Cl. G02B 6/38

(52) U.S. Cl. CPC G02B 6/3831; G02B 6/3825

(57) ABSTRACT

An optical connector according to one embodiment includes a plurality of optical connector plugs collectively connected to a plurality of adapters in a connection direction, each optical connector plug including a ferrule holding an optical fiber, contacting portions located on the opposite side to the adapter with respect to a ferrule end face of the ferrule and coming into contact with each adapter, wherein distances from the ferrule end face to the contacting portions are longer than distances from the ferrule end face to the contacting portions, respectively, determined by optical connector international standards.

### TECHNICAL FIELD

The present disclosure relates to an optical connector comprising a plurality of optical connector plugs that are collectively connected, and adapters.

### BACKGROUND

Japanese Unexamined Patent Publication No. 2012-242781 describes an optical connector that collectively inserts and extracts a plurality of optical connector plugs. The optical connector comprises three plug units, a housing covering the periphery of the three plug units, and a supporting flat plate supporting the three plug units in the housing. Each of the three plug units includes a lock mechanism (latch mechanism) that engages with an adapter.

### SUMMARY

In the above-described optical connector, each of the three optical connector plugs is inserted into the adapter. By the way, when the optical connector plug is inserted into the adapter and engaged, a sound is produced by the latch mechanism. The sound makes it possible to confirm that the optical connector plug is sufficiently inserted.

However, in the case when a plurality of optical connector plugs are collectively engaged, sounds equal to the number of optical connector plugs are produced. Therefore, when the number of optical connector plugs is large, a large number of sounds are produced, and consequently it is difficult to judge whether or not all of the optical connector plugs are sufficiently inserted. Thus, when some of the optical connector plugs is located on the opposite side to the adapter with respect to the other optical connector plugs due to dimensional errors, there is a concern that some of the optical connector plugs is not sufficiently inserted. Hence, reliable and sufficient insertion of a plurality of optical connector plugs is required.

An aspect of the present disclosure is to provide an optical connector and adapters that enable reliable and sufficient insertion of a plurality of optical connector plugs.

An optical connector according to an aspect of the present disclosure is an optical connector comprising a plurality of optical connector plugs collectively connected to a plurality of adapters along a connection direction, each of the optical connector plugs including an ferrule holding an optical fiber, and a contacting portion located on the opposite side to the adapter with respect to a ferrule end face of the ferrule and coming into contact with each adapter, wherein the distance from the ferrule end face to the contacting portion is longer than a distance from the ferrule end face to the contacting portion determined by optical connector international standards.

Adapters according to an aspect of the present disclosure are adapters provided corresponding to a plurality of optical connector plugs, respectively, and to which the optical connector plugs are connected along a connection direction, each of the adapters including a contact portion with which a ferrule provided on the optical connector plug comes into contact, wherein the distance from an adapter end face located on the optical connector plug side to the contact portion is longer than a distance from the adapter end face to the contact portion determined by optical connector international standards.

According to the present disclosure, a plurality of optical connector plugs can be reliably and sufficiently inserted.

### BRIEF DESCRIPTION OF THE DRAWINGS

FIG. 1 is a perspective view showing an optical connector according to a first embodiment;

FIG. 2 is a side view showing an optical connector of FIG. 1;

FIG. 3A is a side view showing a conventional optical connector plug;

FIG. 3B is a side view showing a contacting portion of the conventional optical connector plug;

FIG. 3C is a side view showing an optical connector plug of the optical connector of FIG. 1;

FIG. 4 is a view showing an inserted state of the conventional optical connector plug and an inserted state of the optical connector plug according to the embodiment;

FIG. 5A is a side view showing an adapter;

FIG. 5B is a cross-sectional view showing the adapter;

FIG. 6 is a cross-sectional view showing an optical connector plug and an adapter according to a second embodiment; and

FIG. 7 is a cross-sectional view showing an optical connector plug and an adapter according to a third embodiment.

### DETAILED DESCRIPTION

First, the contents of some embodiments of the present disclosure will be listed and described. An optical connector according to an embodiment of the present disclosure is an optical connector comprising a plurality of optical connector plugs that are collectively connected to a plurality of adapters along a connection direction, each of the optical connector plugs including a ferrule holding an optical fiber, and a contacting portion located on the opposite side to the adapter with respect to a ferrule end face of the ferrule and coming into contact with each adapter, wherein the distance from the ferrule end face to the contacting portion is longer than a distance from the ferrule end face to the contacting portion determined by optical connector international standards.

Adapters according to an embodiment of the present disclosure are adapters provided corresponding to a plurality of optical connector plugs, respectively, and to which the optical connector plugs are connected along a connection direction, each of the adapters including a contact portion with which a ferrule provided on the optical connector plug comes into contact, wherein the distance from an adapter end face located on the optical connector plug side to the contact portion is longer than a distance from the adapter end face to the contact portion determined by optical connector international standards.

An optical connector plug of an optical connector according to an embodiment comprises a ferrule holding an optical fiber, and a contacting portion that comes into contact with an adapter, wherein the distance from a ferrule end face located on the adapter side to the contacting portion is longer than the distance determined by international standards. Since the distance from the ferrule end face to the contacting portion is longer, it is possible to increase an insertion length when the optical connector plug is inserted into the adapter. Therefore, even when some of the optical connector plugs is located on the opposite side to the adapter with respect to the other optical connector plugs due to dimensional errors, all of the optical connector plugs can be reliably and sufficiently inserted because of the longer insertion length. Consequently, it is possible to prevent the problem that some of the optical connector plugs is not sufficiently inserted. Moreover, an adapter according to an embodiment includes a contact portion with which the optical connector plug comes into contact, wherein the distance from an adapter end face to the contact portion is longer than the distance determined by international standards. Thus, since the distance from the adapter end face to the contact portion is longer, it is possible to increase an insertion length that makes the optical connector plug into contact with the contact portion of the adapter. Consequently, since the optical connector plugs can be reliably and sufficiently inserted, the same effects as the effects described above can be obtained.

The optical connector plug may include a front housing storing the ferrule, and a latch mechanism that engages with the adapter, and the contacting portion may include a first contacting portion located on the adapter side of the front housing, and a second contacting portion located on the adapter side of the latch mechanism. In this case, since the distance from the ferrule end face to the first contacting portion of the front housing and the distance from the ferrule end face to the second contacting portion of the latch mechanism are longer, it is possible to increase the insertion length of the optical connector plug. Consequently, all of the optical connector plugs can be reliably and sufficiently inserted.

The optical connector plug may further include a rear housing located on the opposite side of the front housing to the adapter, and the contacting portion may include a third contacting portion located on the adapter side of the rear housing. In this case, since the distance from the ferrule end face to the third contacting portion of the rear housing is longer, it is possible to increase the insertion length of the optical connector plug.

The optical connector plug may include a front housing having a storage concave portion storing the ferrule, and the contacting portion may include a fourth contacting portion that is the bottom surface of the storage concave portion. In this case, since the distance from the ferrule end face to the fourth contacting portion can be made longer than the distance determined by international standards, it is possible to increase the insertion length of the optical connector plug.

The contact portion may include a first contact portion with which the front housing of the optical connector plug comes into contact, and a second contact portion with which the latch mechanism of the optical connector plug comes into contact. In this case, since the distance from the adapter end face to the first contact portion and the distance from the adapter end face to the second contact portion are longer, it is possible to increase the insertion length of the optical connector plug into the adapter.

The contact portion may include a third contact portion with which the rear housing of the optical connector plug comes into contact. In this case, since the distance from the adapter end face to the third contact portion is longer, it is possible to increase the insertion length of the optical connector plug into the adapter.

The contact portion may include an engagement projection of the latch mechanism that engages with an engagement concave portion of the optical connector plug. In this case, since the distance from the adapter end face to the engagement projection is longer, it is possible to increase the insertion length of the optical connector plug into the adapter.

### DETAILS OF EMBODIMENTS OF PRESENT DISCLOSURE

Specific examples of optical connectors according to some embodiments of the present disclosure will be described with reference to the drawings. The present disclosure is not limited to the following illustrative examples, but is specified by the scope of claims and is meant to include all modifications within the scope equivalent to the scope of the claims. In the description of the drawings, the same or corresponding components are labelled with the same reference numerals, and redundant explanation will be omitted as appropriate.

In the present description, “optical connector international standards” include: IEC 61754-20 (Fibre optic connector interfaces—Part 20: Type LC connector family) that defines the standards for LC connectors; IEC 61754-4 (Fibre optic interconnecting devices and passive components—Fibre optic connector interfaces—Part 4: Type SC connector family) that defines the standards for SC connectors; and IEC 61754-7 (Fibre optic interconnecting devices and passive components—Fibre optic connector interfaces—Part 7-1: Type MPO connector family—One fibre row) that defines the standards for MPO connectors.

### First Embodiment

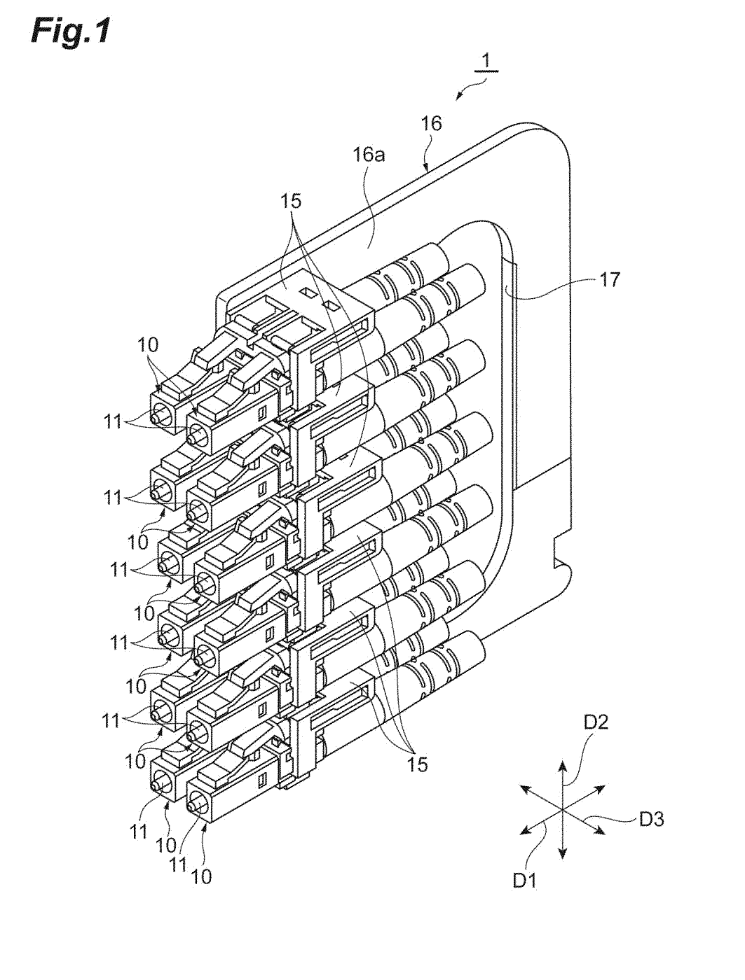

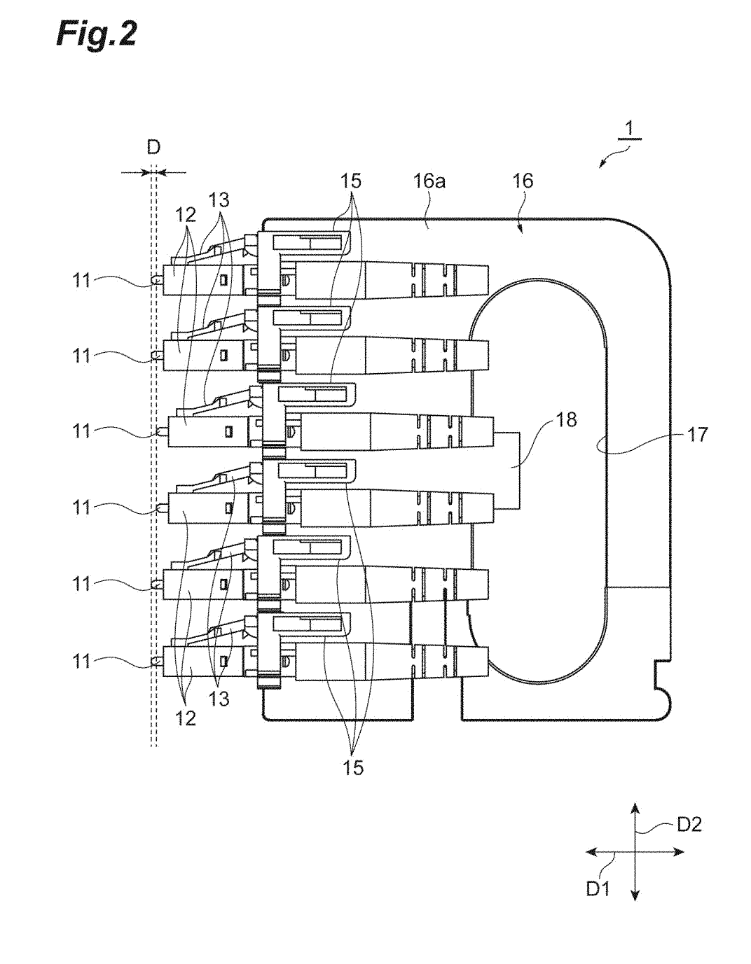

FIG. 1 is a perspective view showing an optical connector 1 according to the first embodiment. FIG. 2 is a side view of the optical connector 1. The optical connector 1 is, for example, an optical connector for inspection, included in an inspection apparatus that inspects optical communication between a plurality of data centers. On a data center rack, an optical distribution frame to which a plurality of optical fibers are fused is mounted. The inspection of optical communication is carried out by connecting the optical connector 1 to a plurality of adapters arranged on the optical distribution frame.

In recent years, with an increase in the amount of data communication, adopting a multi-fiber structure for the optical distribution frame is in progress, and the number of adapters is steadily increasing. For example, the number of adapters provided for one optical distribution frame is 288. Since the optical connector 1 is collectively inserted and removed with respect to a plurality of adapters, even when the number of adapters is large, it is possible to reduce the time taken for insertion and removal.

The optical connector 1 comprises twelve optical connector plugs 10 connected to respective adapters, holders 15 holding the optical connector plugs 10, and a support member 16 to which the holders 15 are fixed. The optical connector 1 is connected to the adapters along a direction D1 that is a connection direction. The optical connector plugs 10 and the adapters are aligned along a direction D2 intersecting the direction D1 For example, the direction D1 is a direction in which the optical connector plugs 10 protrude from the holders 15, and the direction D2 is a direction orthogonal to the direction D1.

The plurality of optical connector plugs 10 are arranged along the direction D2 and also arranged along a direction D3 intersecting the direction D1 and the direction D2. As a specific example, six optical connector plugs 10 are arranged along the direction D2, and two optical connector plugs 10 are arranged along the direction D3. The direction D3 is a direction crossing planes extending in the direction D1 and direction D2, and is, for example, orthogonal to the planes extending in the direction D1 and direction D2.

The optical connector plug 10 is an LC connector. The optical connector plug 10 comprises a ferrule 11 holding an optical fiber, a front housing 12 storing the ferrule 11, and a latch mechanism 13 that engages the optical connector plug 10 with the adapter. In the following description, the direction in which the adapter is provided with respect to the ferrule 11 will sometimes be referred to as the front, and the opposite direction will sometimes be referred to as the rear.

For example, the ferrules 11 extending from some optical connector plugs 10 among the plurality of optical connector plugs 10 are located on the adapter side with respect to the ferrules 11 extending from the remaining optical connector plugs 10. In short, the end portions of some of the ferrules 11 protrude by a protrusion amount D from the end portions of the remaining ferrules 11. The value of the protrusion amount D is, for example, 0.1 mm or more and 0.5 mm or less, but the value of the protrusion amount D can be appropriately changed.

In the present embodiment, the ferrules 11 located on both end sides in the direction D2 protrude to the adapter side from the ferrules 11 located on the center side in the direction D2. As a specific example, the eight ferrules 11 on both end sides in the direction D2 protrude to the adapter side from the four ferrules 11 on the center side in the direction D2. The number and arrangement of the optical connector plugs 10 comprising the ferrules 11 protruding to the adapter side can be appropriately changed.

Thus, since the ferrules 11 of some of the optical connector plugs 10 protrude from the ferrules 11 of the remaining optical connector plugs 10, there is a difference in the mount positions of the optical connector plugs 10 in the direction D1. Hence, it is possible to shift the timing of insertion resistance produced in each optical connector plug 10 at the time of insertion into the adapter, thereby avoiding concentration of insertion resistance.

The holder 15 collectively holds a plurality of optical connector plugs 10 aligned in the direction D3. The holders 15 are aligned along the direction D2, and each holder 15 is fixed to the support member 16. For example, six holders 15 are provided, and each holder 15 holds two optical connector plugs 10.

The support member 16 may have a pushing portion 18 that pushes the four optical connector plugs 10 located on the center side in the direction D2 toward the adapter side. The support member 16 is, for example, in the form of a plate. The support member 16 has a main surface 16a to which each holder 15 is fixed, and the main surface 16a is directed to one side in the direction D3. For example, the four holders 15 located on both end sides in the direction D2 protrude more toward the adapter side than the remaining two holders 15.

The support member 16 includes a grip portion 17 located behind the optical connector plugs 10. The grip portion 17 is formed by an opening penetrating through the support member 16 and has a shape that is easy to grip by inserting fingers into the opening and gripping the grip portion 17. The opening that forms the grip portion 17 is, for example, in the shape of an oval extending along the direction D2.

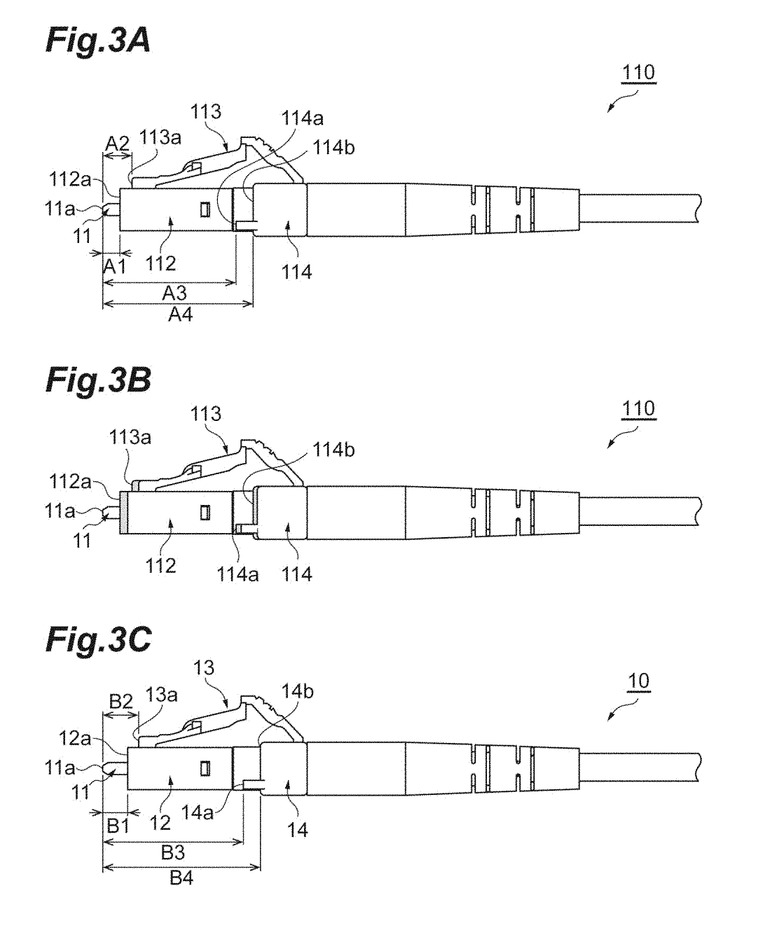

Next, optical connector plugs will be described in detail with reference to FIGS. 3A to 3C. First, a conventional optical connector plug 110 will be described. The optical connector plug 110 is an LC connector. The optical connector plug 110 comprises the ferrule 11, a front housing 112 storing the ferrule 11, a latch mechanism 113 that engages the optical connector plug 110 with an adapter, and a rear housing 114 located on the rear side of the front housing 112.

The front end of the front housing 112, the front end of the latch mechanism 113, and the front end of the rear housing 114 are a first contacting portion 112a, a second contacting portion 113a, and a third contacting portion 114a and a fourth contacting portion 114b, respectively. The first contacting portion 112a, the second contacting portion 113a, the third contacting portion 114a, and the forth contacting portion 114b contact an adapter respectively. The first contacting portion 112a is located at the front end of the front housing 112, and the second contacting portion 113a is located at the front end of the latch mechanism 113. The third contacting portion 114a protrudes forward from the fourth contacting portion 114b.

The optical connector plug 110 is an optical connector plug conforming to LC connector standards. A distance A1 from a ferrule end face 11a located at the front end of the ferrule 11 to the first contacting portion 112a, a distance A2 from the ferrule end face 11a to the second contacting portion 113a, and a distance A3 from the ferrule end face 11a to the third contacting portion 114a conform to international standards. The distance A1 is 1.38 mm or more and 1.70 mm or less, the distance A2 is 2.48 mm or more and 3.00 mm or less, and the distance A3 is 13.58 mm or more. A distance A4 from the ferrule end face 11a to the fourth contacting portion 114b is 14.73 mm or more.

The optical connector plug 10 according to the present embodiment is formed by, for example, processing the first contacting portion 112a, the second contacting portion 113a, the third contacting portion 114a and the fourth contacting portion 114b from the optical connector plug 110. As a specific example, the front end portions of the first contacting portion 112a, the second contacting portion 113a, the third contacting portion 114a and the fourth contacting portion 114b are removed.

Consequently, a distance B1 from the ferrule end face 11a to the first contacting portion 12a of the front housing 12, a distance B2 from the ferrule end face 11a to the second contacting portion 13a of the latch mechanism 13, a distance B3 from the ferrule end face 11a to the third contacting portion 14a of the rear housing 14, and a distance B4 from the ferrule end face 11a to the third contacting portion 14b of the rear housing 14 are longer than the distances A1, A2, A3, A4, respectively.

In short, the distances B1 to B4 are longer than the distances A1 to A4, respectively, determined by LC connector standards. For example, the distance B1 is longer than 1.70 mm and 2.00 mm or less, the distance B2 is longer than 3.0 mm and 3.6 mm or less, the distance B3 is 13.9 mm or more, and the distance B4 is 15.1 mm or more.

Next, the function and effects obtained from the optical connector 1 according to the present embodiment will be described.

The optical connector plug 10 of the optical connector 1 comprises the ferrule 11 holding an optical fiber, and contacting portions 12a, 13a, 14a, 14b that come into contact with an adapter, and the distances B1, B2, B3, B4 from the ferrule end face 11 a located on the adapter side to the contacting portion 12a, 13a, 14a, 14b are longer than the distances A1, A2, A3, A4, respectively, determined by international standards.

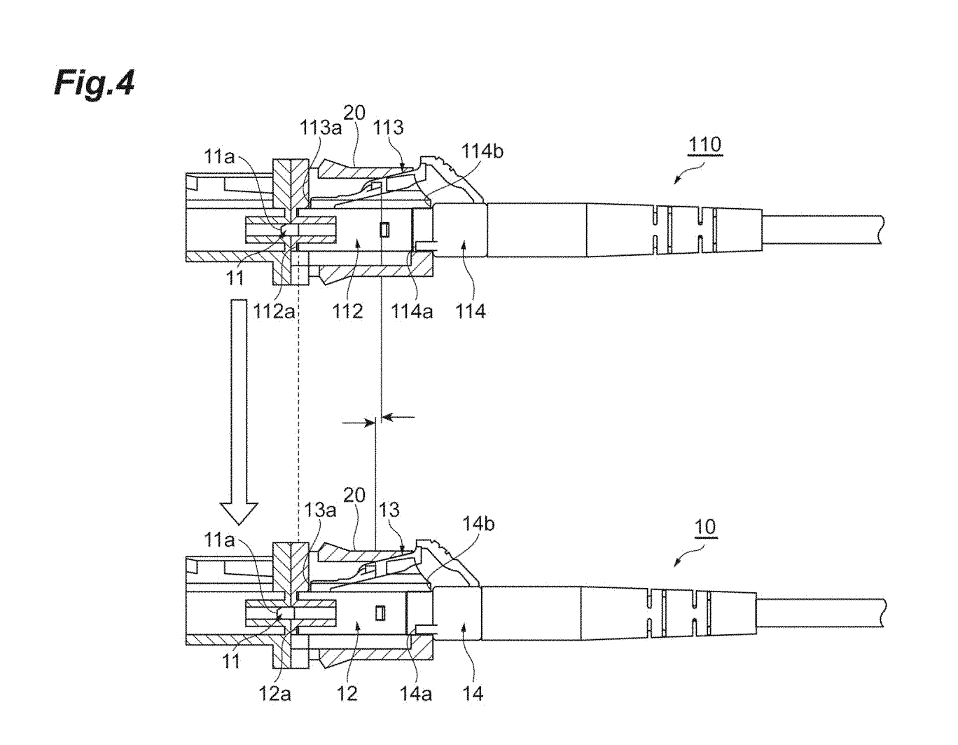

As shown in FIGS. 3A to 3C and FIG. 4, since the distances B1, B2, B3, B4 from the ferrule end face 11 a to the contacting portions 12a, 13a, 14a, 14b are longer, it is possible to increase an insertion length at the time the optical connector plug 10 is inserted into the adapter 20. Therefore, even when some of the optical connector plugs 10 are located on the opposite side to the adapter 20 with respect to the other optical connector plugs 10 due to dimensional errors, all of the optical connector plugs 10 can be reliably and sufficiently inserted because of the longer insertion length. Hence, it is possible to prevent the problem that some of the optical connector plugs 10 are not sufficiently inserted.

The optical connector plug 10 has the front housing 12 storing the ferrule 11 and the latch mechanism 13 that engages with the adapter 20, and the contacting portion includes the first contacting portion 12a located on the adapter 20 side of the front housing 12 and the second contacting portion 13a located on the adapter 20 side of the latch mechanism 13.

Thus, since the distance B1 from the ferrule end face 11a to the first contacting portion 12a and the distance B2 from the ferrule end face 11a to the second contacting portion 13a are longer, it is possible to increase the insertion length of the optical connector plug 10. Hence, all of the optical connector plugs 10 can be reliably and sufficiently inserted.

The optical connector plug 10 further has the rear housing 14 located on the opposite side of the front housing 12 to the adapter 20, and the contacting portion includes the third contacting portions 14a, 14b located on the adapter 20 side of the rear housing 14. Thus, since the distances B3, B4 from the ferrule end face 11 a to the third contacting portions 14a, 14b can be made longer than the distances A3, A4 determined by international standards, it is possible to increase the insertion length of the optical connector plug 10.

### Second Embodiment

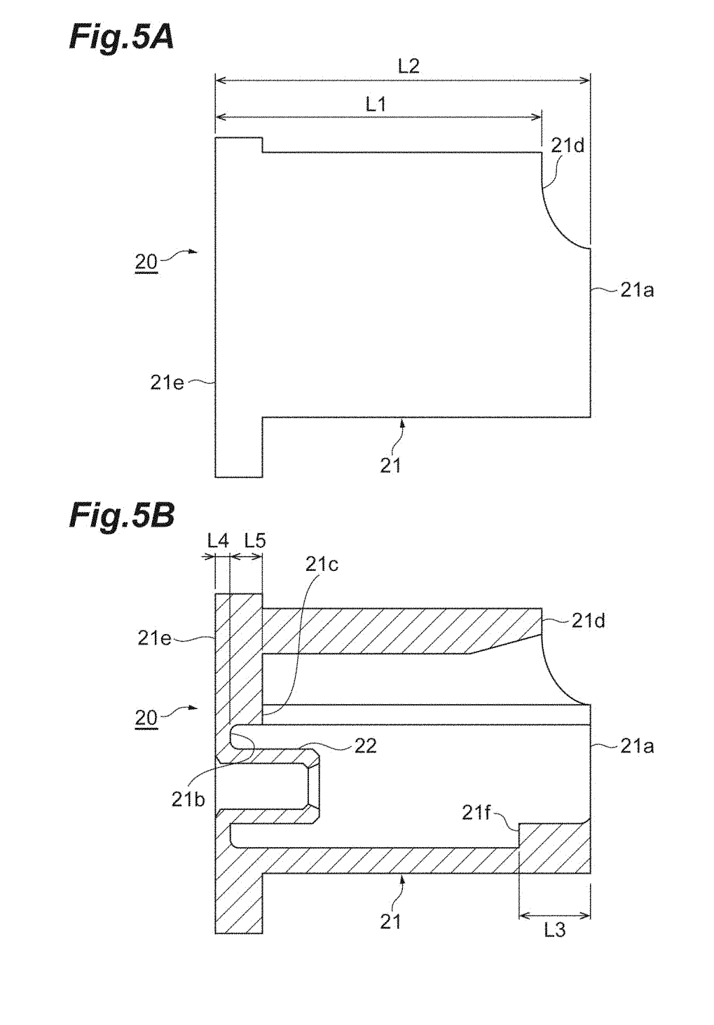

Next, the second embodiment will be described with reference to FIGS. 5A and 5B. The adapter 20 according to the second embodiment comprises a housing storage portion 21 in a tubular shape with a bottom for storing the front housing 12 of the optical connector plug 10, and a ferrule storage portion 22 in a tubular shape for storing the ferrule 11 in the housing storage portion 21. Description redundant to the above-described contents will be omitted below as appropriate.

The housing storage portion 21 has, at the rear end, an adapter end face 21a with which the third contacting portion 14b of the rear housing 14 comes into contact. The bottom of the housing storage portion 21 has a first contact portion 21b with which the first contacting portion 12a of the front housing 12 comes into contact, and a second contact portion 21c with which the contacting portion 13a of the latch mechanism 13 comes into contact. Further, the housing storage portion 21 has a third contact portion 21d that is cut out forward from the adapter end face 21a and with which the latch mechanism 13 of the front housing 12 comes into contact.

A distance L1 from a front end 21e of the housing storage portion 21 to the third contact portion 21d and a distance L2 from the adapter end face 21a to the front end 21e are shorter than the distances determined by LC connector standards. For example, the distance L1 is 10.7 mm or less, and the distance L2 is 14.0 mm or less.

A distance L3 from the adapter end face 21a to a fourth contact portion 21f in the adapter is longer than the distance determined by LC connector standards. The distance L3 is, for example, longer than 2.3 mm and 2.8 mm or less. The sum of a distance L4 from the front end 21e to the first contact portion 21b and a distance L5 from the first contact portion 21b to the second contact portion 21c is less than the distance determined by LC connector standards, and is, for example, less than 1.4 mm

As described above, the adapter 20 according to the second embodiment comprises the contact portions 21b, 21c, 21d with which the optical connector plug 10 comes into contact, and the distances from the adapter end face 21a to the contact portions 21b, 21c, 21d are longer than the distances determined by international standards. Thus, since the distances from the adapter end face 21a to the respective contact portions 21b, 21c, 21d are longer, it is possible to increase the insertion length of the optical connector plug 10. Hence, since the optical connector plugs 10 can be reliably and sufficiently inserted, the same effects as in the first embodiment can be obtained.

The contact portion includes the first contact portion 21b with which the front housing 12 comes into contact, and the second contact portion 21c with which the latch mechanism 13 comes into contact. Thus, since the distance from the adapter end face 21a to the first contact portion 21b and the distance from the adapter end face 21a to the second contact portion 21c are longer, it is possible to increase the insertion length of the optical connector plug 10 into the adapter 20.

The contact portion includes the third contact portion 21d with which the latch mechanism 13 comes into contact. Since the distance L3 from the adapter end face 21a to the fourth contact portion 21f in the adapter is longer, it is possible to increase the insertion length of the optical connector plug 10 into the adapter 20.

### Third Embodiment

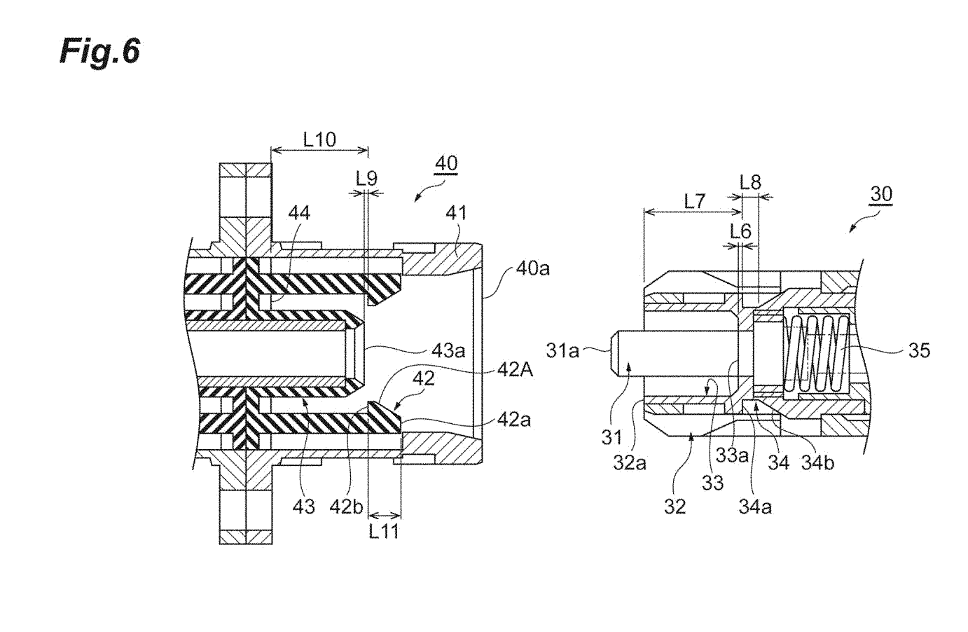

Subsequently, an optical connector plug 30 and an adapter 40 according to the third embodiment will be described with reference to FIG. 6. The optical connector plug 30 and the adapter 40 conform to SC connector standards. The optical connector plug 30 comprises a ferrule 31 holding an optical fiber, a front housing 32 storing the ferrule 31, and a spring 35 that urges the ferrule 31.

The ferrule 31 is in a tubular shape and has a ferrule end face 31a at the front end. The front housing 32 has a storage concave portion 33 storing the ferrule 31, and a bottom surface of the storage concave portion 33 is a fourth contacting portion 33a that comes into contact with the adapter 40. The front housing 32 has, on a surface, an engagement concave portion 34 that engages with the adapter 40. The engagement concave portion 34 has a latch contacting surface 34a standing upright from the front end of the bottom surface thereof, and an inclined surface 34b located on the rear side of the bottom surface of the engagement concave portion 34.

A distance L6 from the latch contacting surface 34a to the fourth contacting portion 33a and a distance L7 from the latch contacting surface 34a to the front end 32a of the front housing 32 are both shorter than the distances determined by SC connector standards. Thus, the distance from the ferrule end face 31a to the front end 32a and the distance from the ferrule end face 31a to the fourth contacting portion 33a are both longer than the distances determined by SC connector standards. For example, the distance L6 may be −0.4 mm or more and less than −0.2 mm, and the distance L7 may be 5.0 mm or more and less than 5.2 mm. A distance L8 from the latch contacting surface 34a to the front end of the inclined surface 34b is longer than the value determined by SC connector standards, and, for example, is longer than 1.2 mm and 1.6 mm or less.

The adapter 40 comprises a tubular housing 41, a latch mechanism 42 that engages with the optical connector plug 30 in the housing 41, and a sleeve 43 into which the ferrule 31 is inserted inside the latch mechanism 42. The latch mechanism 42 has an engagement projection 42A that engages with the engagement concave portion 34 of the optical connector plug 30. The engagement projection 42A has a rear end face 42a and a locking surface 42b where the latch contacting surface 34a is locked in front of the rear end face 42a. A contact portion 44 with which the front end 32a of the front housing 32 comes into contact is provided between the latch mechanism 42 and the sleeve 43.

A distance L9 from the locking surface 42b to the rear end face 43a of the sleeve 43 and a distance L10 from the locking surface 42b to the contact portion 44 are longer than the distances determined by SC connector standards. Thus, the distance from the adapter end face 40a to the rear end face 43a of the adapter 40 and the distance from the adapter end face 40a to the contact portion 44 are both longer than the distances determined by SC connector standards.

For example, the distance L9 is longer than 0.4 mm and 1.4 mm or less, and the distance L10 is longer than 5.9 mm and 6.5 mm or less. A distance L11 from the locking surface 42b to the rear end face 42a is shorter than the value determined by SC connector standards. Consequently, the distance from the adapter end face 40a to the latch mechanism 42 (rear end face 42a) is longer than the distance determined by SC connector standards. For example, the distance L11 is 1.6 mm or more and less than 1.8 mm.

As described above, the optical connector plug 30 has the front housing 32 including the storage concave portion 33 storing the ferrule 31, and the contacting portion includes the fourth contacting portion 33a that is the bottom surface of the storage concave portion 33. Since the distance from the ferrule end face 31a to the fourth contacting portion 33a is longer than the distance determined by SC connector standards, it is possible to increase the insertion depth of the optical connector plug 30.

The contact portion of the adapter 40 includes the engagement projection 42A of the latch mechanism 42 that engages with the engagement concave portion 34 of the optical connector plug 30. Thus, since the distance from the adapter end face 40a to the engagement projection 42A is longer, it is possible to increase the insertion length of the optical connector plug 30 into the adapter 40.

### Fourth Embodiment

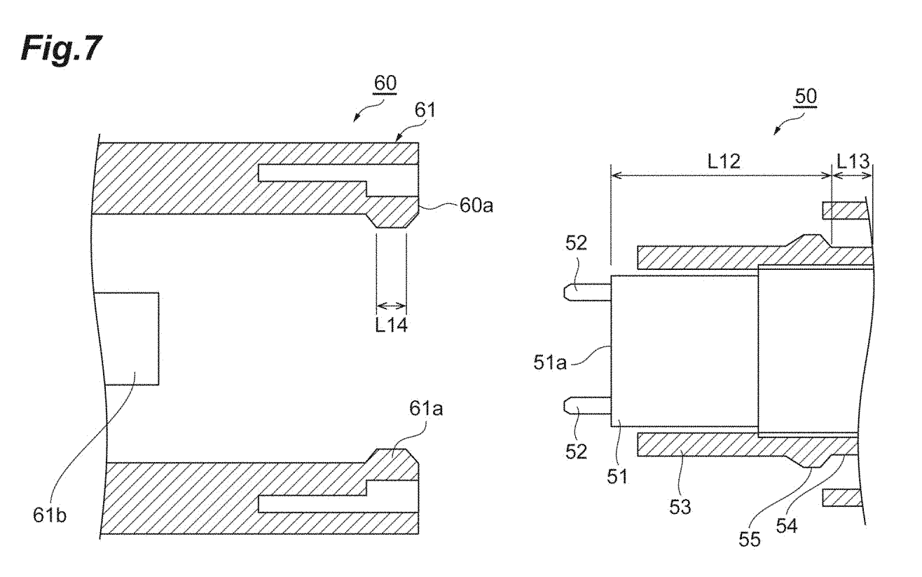

Next, an optical connector plug 50 and an adapter 60 according to the fourth embodiment will be described with reference to FIG. 7. The optical connector plug 50 and the adapter 60 conform to MPO connector standards. The optical connector plug 50 comprises a ferrule 51 holding an optical fiber, guide pins 52 for positioning the optical connector plug 50 and the adapter 60, and a front housing 53 storing the ferrule 51. The guide pins 52 may also be provided on the adapter 60 side. In this case, guide holes into which the guide pins of the adapter 60 are inserted are formed at positions where the guide pins 52 of the optical connector plug 50 are present.

The ferrule 51 has a rectangular shape. The front housing 53 has, on a surface, an engagement concave portion 54 and an engagement projection 55 that engage with the adapter 60. The engagement concave portion 54 is provided behind the engagement projection 55. A distance L12 from the front end of the engagement concave portion 54 to the ferrule end face 51a is shorter than the distance determined by MPO connector standards. For example, the distance L12 is 8.4 mm or more and less than 8.8 mm A distance L13 from the front end of the engagement concave portion 54 to the rear end of the engagement concave portion 54 is more than the value determined by MPO connector standards. The distance L13 is, for example, 1.8 mm or more.

The adapter 60 comprises a tubular housing 61 for storing the optical connector plug 50. The housing 61 internally includes an engagement projection 61a with which the optical connector plug 50 engages, and a groove portion 61b into which a key projection formed on the optical connector plug 50 enters. A distance L14 from the front end of the engagement projection 61a to the rear end of the engagement projection 61a is shorter than the distance determined by WO connector standards. Consequently, the distance from an adapter end face 60a of the adapter 60 to the rear end of the engagement projection 61a is longer than the distance determined by MPO connector standards. For example, the distance L14 is less than 1.00 mm. Since the groove portion 61b is extended forward beyond the groove portion determined by MPO connector standards, it is possible to insert the optical connector plug 50 deeper into the adapter 60.

As described above, the contact portion of the adapter 60 includes the engagement projection 61a that engages with the engagement concave portion 54 of the optical connector plug 50. Thus, since the distance from the adapter end face 60a to the rear end of the engagement projection 61a is longer, it is possible to increase the insertion length of the optical connector plug 50 into the adapter 60. Consequently, since the optical connector plug 50 can be inserted deeper, the same effects as the effects of the above-described embodiments can be obtained.

The embodiments of the present disclosure have been described, but the present disclosure is not limited to the above-described embodiments, and various modifications can be made. For example, in the above embodiment, the optical connector plug 10 including the rear housing 14 is described, but the optical connector plug may be an optical connector plug having no rear housing. Thus, the shape, size, material, number and arrangement of each part of the optical connector plug are not limited to the above-described embodiment and can be appropriately changed.

The above embodiment describes the optical connector 1 in which the ferrules 11 of some of the optical connector plugs 10 protrude from the ferrules 11 of the remaining optical connector plugs 10. However, the optical connector may be an optical connector in which the ferrules of some of the optical connector plugs do not protrude. Thus, the shape, size, material, number and arrangement of each part of the optical connector are not limited to the above-described embodiment and can be appropriately changed.

What is claimed is:

1. An optical connector comprising a plurality of optical connector plugs collectively connected to a plurality of adapters along a connection direction, each of the optical connector plugs including: a ferrule holding an optical fiber; and a contacting portion located on an opposite side to the adapter with respect to a ferrule end face of the ferrule and coming into contact with each adapter, wherein
a distance from the ferrule end face to the contacting portion is longer than a distance from the ferrule end face to the contacting portion determined by optical connector international standards.

2. An adapter provided for each of a plurality of optical connector plugs such that the optical connector plug is connected to the adapter along a connection direction, the adapter including a contact portion with which the optical connector plug comes into contact, wherein
a distance from an adapter end face located on the optical connector plug side to the contact portion is longer than a distance from the adapter end face to the contact portion determined by optical connector international standards.

3. The optical connector according to claim 1, wherein
the optical connector plug includes a front housing storing the ferrule, and a latch mechanism that engages with the adapter, and
the contacting portion includes a first contacting portion located on an adapter side of the front housing, and a second contacting portion located on an adapter side of the latch mechanism.

4. The optical connector according to claim 3, wherein
the optical connector plug further includes a rear housing located on an opposite side of the front housing to the adapter, and
the contacting portion includes a third contacting portion located on the adapter side of the rear housing.

5. The optical connector according to claim 1, wherein
the optical connector plug includes a front housing having a storage concave portion storing the ferrule, and
the contacting portion includes a fourth contacting portion that is a bottom surface of the storage concave portion.

6. The adapter according to claim 2, wherein
the contact portion includes a first contact portion with which a front housing of the optical connector plug comes into contact, and a second contact portion with which a latch mechanism of the optical connector plug comes into contact.

7. The adapter according to claim 6, wherein
the contact portion includes a third contact portion with which a rear housing of the optical connector plug comes into contact.

8. The adapter according to claim 2, wherein
the contact portion includes an engagement projection of a latch mechanism that engages with an engagement concave portion of the optical connector plug.
